(19) United States
(12) Patent Application Publication
(10) Pub. No.: US 2021/0370503 A1
(43) Pub. Date: Dec. 2, 2021

(54) METHOD AND SYSTEM FOR PROVIDING DYNAMIC CROSS-DOMAIN LEARNING

(71) Applicant: Wipro Limited, Bangalore (IN)

(72) Inventors: Shashidhar SOPPIN, Bangalore (IN); Chandrashekar Bangalore NAGARAJ, Bangalore (IN); Manjunath Ramachandra IYER, Bangalore (IN)

(21) Appl. No.: 16/992,472

(22) Filed: Aug. 13, 2020

(30) Foreign Application Priority Data
May 29, 2020 (IN) 202041022723

(51) Int. Cl. B25J 9/16; G06N 20/00

(52) U.S. Cl. CPC B25J 9/163; G06N 20/00

(57) ABSTRACT

A method and dynamic learning system for providing dynamic cross learning is disclosed. The dynamic learning system identifies one or more changes in an environment in which an automated task performing device is scheduled to perform one or more activities. The dynamic learning system initiates a dynamic learning associated with the one or more changes for the automated task performing device based on pre-stored contextual information. Based on the dynamic learning, one or more actions is provided to the automated task performing device to perform the one or more activities in view of the one more changes. Therefore, the present disclosure facilitates dynamic determination and analysis of environment and situation for the automated task performing device for performing the activities. Thus, leading to dynamic decision-making to provide adjustment to the automated task performing device in any situation.

### TECHNICAL FIELD

The present subject matter is related in general to automated system and cross-domain learning, more particularly, but not exclusively to method and system for providing dynamic cross-domain learning.

### BACKGROUND

Automated devices have become an essential part of everyday life in various context, for example, as an assistants at home, in automated vehicles, as an appliances, in industrial environments and the like. In this context, creating automated devices that can learn to act in unpredictable environments has been a long-standing requirement.

Generally, significant amount of time is invested in detecting objects of interest in automated environment, especially if there is any change in domain. In such scenarios, obtaining preferred services or arranging things/items in a specific way may consume lot of time for users. In current situation, identifying problems of automated devices and suggesting relevant solution dynamically is highly appreciated.

Conventional mechanisms determine object of interest based on preferences. However, these mechanisms lack in identifying domain specific changes. For example, identifying any physical objects such as, screwdriver, spanner, and tools for industry specific needs. Although conventional mechanisms recommend similar objects if the automate device has never seen such kind of objects earlier. These conventional mechanisms are highly application specific or capture static and preset parameters. Typically, the conventional mechanisms revolve around “user preference” as main criteria for selecting next course of actions. Many conventional mechanisms perform actions based on stored preferences without updating them depending on new domain techniques. The conventional mechanisms do not include dynamic models, which addresses ever changing scenarios, other than the user preferences such as, surrounding environment, and various other factors, which may affect overall system.

Thus, currently there are no mechanisms for performing cross-domain based learning for seamless transfer of dynamic information related to contextual activities. The conventional mechanisms capture all interactions associated with environment, which are subsequently analyzed and updated dynamically. However, only routine, and occasional based activities are captured for user-based preferences.

The information disclosed in this background of the disclosure section is only for enhancement of understanding of the general background of the invention and should not be taken as an acknowledgment or any form of suggestion that this information forms the prior art already known to a person skilled in the art.

### SUMMARY

In an embodiment, the present disclosure may relate to a method for providing dynamic cross-domain learning. The method comprises identifying one or more changes in an environment in which an automated task performing device is scheduled to perform one or more activities. The method includes initiating a dynamic learning associated with the one or more changes for the automated task performing device based on pre-stored contextual information. Thereafter, based on the dynamic learning, the method includes providing one or more actions to the automated task performing device to perform the one or more activities in view of the one more changes.

In an embodiment, the present disclosure may relate to a dynamic learning system for providing dynamic cross-domain learning. The dynamic learning system may comprise a processor and a memory communicatively coupled to the processor, where the memory stores processor executable instructions, which, on execution, may cause the dynamic learning system to identify one or more changes in an environment in which an automated task performing device is scheduled to perform one or more activities. A dynamic learning associated with the one or more changes is initiated for the automated task performing device based on pre-stored contextual information. Thereafter, based on the dynamic learning, the dynamic learning system provides one or more actions to the automated task performing device to perform the one or more activities in view of the one more changes.

In an embodiment, the present disclosure relates to a non-transitory computer readable medium including instructions stored thereon that when processed by at least one processor may cause a dynamic learning system to identify one or more changes in an environment in which an automated task performing device is scheduled to perform one or more activities. A dynamic learning associated with the one or more changes is initiated for the automated task performing device based on pre-stored contextual information. Thereafter, based on the dynamic learning, the instructions causes the processor to provide one or more actions to the automated task performing device to perform the one or more activities in view of the one more changes.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for providing dynamic cross-domain learning in accordance with some embodiments of the present disclosure;

FIG. 2 shows a detailed block diagram of a dynamic learning system in accordance with some embodiments of the present disclosure;

FIG. 3a-3c show exemplary tables for providing dynamic cross-domain learning in accordance with some embodiments of the present disclosure;

FIG. 4 shows an exemplary embodiment automated task performing device for dynamic cross-domain learning in accordance with some embodiments of present disclosure;

FIG. 5 illustrates a flowchart showing a method for providing dynamic cross-domain in accordance with some embodiments of present disclosure; and

FIG. 6 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure may relate to a method and dynamic learning system for providing dynamic cross-domain learning for an automated task performing device. The automated task performing device may refer to a device for performing one or more automated activities in various environment. As an example, the automated task performing device may include, industrial robots, chatbots, bots, automated vehicles, home automation devices and the like. Typically, the automated task performing device may perform one or more activities learned previously based on preferences-based parameters. Thus, current approach is dependent on such preference-based parameters. However, this approach lacks in identifying and suggesting actions with domain specific changes and does not provide dynamic interaction-based learning. Thus, there are no mechanisms for performing cross-domain based learning.

The present disclosure resolves this problem by performing a dynamic learning based on pre-stored contextual information. Particularly, on identifying one or more changes in an environment in which an automated task performing device is scheduled to perform activities, the dynamic learning for the one or more changes is initiated for the automated task performing device. Thus, based on the learning, one or more actions is provided to the automated task performing device to perform the one or more activities in view of the one more changes. Therefore, the present disclosure facilitates dynamic determination and analysis of environment and situation for the automated task performing device for performing the activities. Thus, leading to dynamic decision-making to provide adjustment to the automated task performing device in any situation.

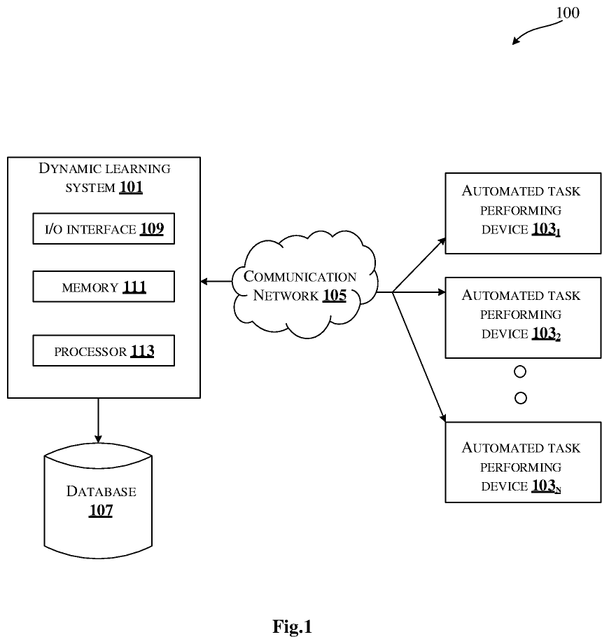

FIG. 1 illustrates an exemplary environment for providing dynamic cross-domain learning in accordance with some embodiments of the present disclosure.

As shown in FIG. 1, an environment 100 includes a dynamic learning system 101 connected to an automated task performing device 103₁, an automated task performing device 103₂, . . . and an automated task performing device 103_{N} (collectively referred as plurality of automated task performing devices 103) through a communication network 105. Further, the dynamic learning system 101 may be connected to a database 107 for storing data associated with the plurality of automated task performing devices 103. In the present disclosure, an automated task performing device may be a device which performs one or more automated activities without user intervention in various environments. For instance, the automated task performing device may be an industrial robot, a bot, a chatbot in a computing device, an automation device in smart environment, an autonomous vehicle, and the like. A person skilled in the art would understand that any other automated devices in an environment, not mentioned herein explicitly, may also be referred as the automated task performing device.

In an embodiment, the communication network 105 may include, but is not limited to, a direct interconnection, a Peer-to-Peer (P2P) network, Local Area Network (LAN), Wide Area Network (WAN), wireless network (for example, using Wireless Application Protocol), Internet, Wi-Fi and the like.

The dynamic learning system 101 may provide dynamic cross domain learning for the plurality of automated task performing devices 103. The dynamic learning system 101 may include, but is not limited to, a laptop, a desktop computer, a notebook, a smartphone, IOT devices, system, a tablet, a server, and any other computing devices. A person skilled in the art would understand that, any other devices, not mentioned explicitly, may also be used as the dynamic learning system 101 in the present disclosure. In an embodiment, the dynamic learning system 101 may be implemented with the plurality of automated task performing devices 103.

Further, the dynamic learning system 101 may include an I/O interface 109, a memory 111 and a processor 113. The I/O interface 109 may be configured to receive data from the plurality of automated task performing devices 103. The data from the I/O interface 109 may be stored in the memory 111. The memory 111 may be communicatively coupled to the processor 113 of the dynamic learning system 101. The memory 111 may also store processor instructions which may cause the processor 113 to execute the instructions for providing the dynamic cross domain learning.

An automated task performing device of the plurality of automated task performing devices 103 may be configured to perform one or more activities in an environment. The term environment may refer to a set of conditions related to a domain under which the automated task performing device operates. In some situations, the environment may also be position based such as, different rooms in a building or attribute based such as, same room under different conditions, different parameters, and the like. Further, the one or more activities may vary depending on type of the automated task performing device and the environment. While the automated task performing device is exposed to the environment, the dynamic learning system 101 monitors the environment in which an automated task performing device is scheduled to perform the one or more activities. The environment may be monitored to identify one or more changes in the environment. In an embodiment, the one or more changes may be related to scheduled routine and one or more objects in the environment. For instance, the one or more changes with respect to the one or more objects may be change in dimension of objects, misplacing or replacing of the objects and the like. In an embodiment, the dynamic learning system 101 may provide an alert to the automated task performing device on identifying the one or more changes in the environment.

Further, the one or more changes in the environment are identified using pre-determined interaction information associated with the automated task performing device of the plurality of automated task performing devices 103. The pre-determined interaction information may include a plurality of labeled activity data with associated timestamp. For instance, in an industrial environment, the labeled activity may be picking of screws and inputs, bolting nuts and the like. The interaction information is determined by capturing interactions of each of the plurality of automated task performing devices 103 with one or more objects in one or more environment and one or more objects in the one or more environment. The interaction informed is captured using a plurality of sensing devices located in the environment. For example, the plurality of sensing devices may include, camera, mobile phone, and the like. A person skilled in the art would understand that any other type of sensing devices, not mentioned herein explicitly, may also be used for monitoring the interaction information. The pre-determined interaction information is explained in detail in subsequent figures of the present disclosure.

On identifying the one or more changes, the dynamic learning system 101 may initiate a dynamic learning associated with the one or more changes for the automated task performing device. The dynamic learning system 101 may initiate the dynamic learning based on pre-stored contextual information using one or more machine learning models. In an embodiment, the one or more machine learning models may include Convolutional Neural Network (CNN) model, Long Short-Term Memory (LSTM) model and the like. The pre-stored contextual information may include details on a plurality of activities and corresponding one or more actions performed by the plurality of automated task performing devices 103 in one or more environment. In an embodiment, the dynamic learning system 101 may determine the contextual information periodically based on the pre-determined interaction information and includes preference actions with associated timestamp, a state of one or more objects, weights associated with each action and metadata comprising type of action, frequency rate of object interactions and nature of object actions. Upon dynamic learning, the dynamic learning system 101 may provide one or more actions to the automated task performing device to perform the one or more activities in view of the one more changes. Further, the one or more actions performed by the automated task performing device may be monitored and updated in the pre-stored contextual information.

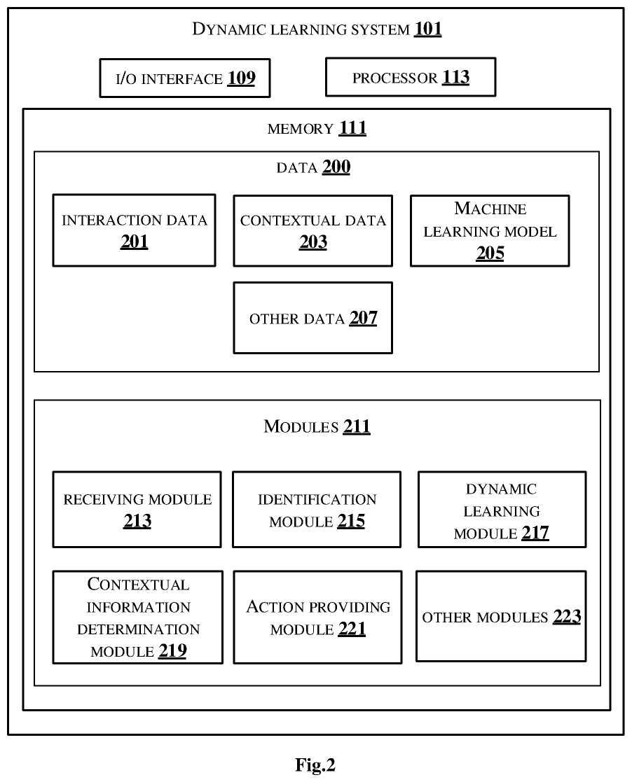

FIG. 2 shows a detailed block diagram of a dynamic learning system in accordance with some embodiments of the present disclosure.

The dynamic learning system 101 may include data 200 and one or more modules 211 which are described herein in detail. In an embodiment, data 200 may be stored within the memory 111. The data 200 may include, for example, interaction data 201, contextual data 203, machine learning model 205 and other data 207.

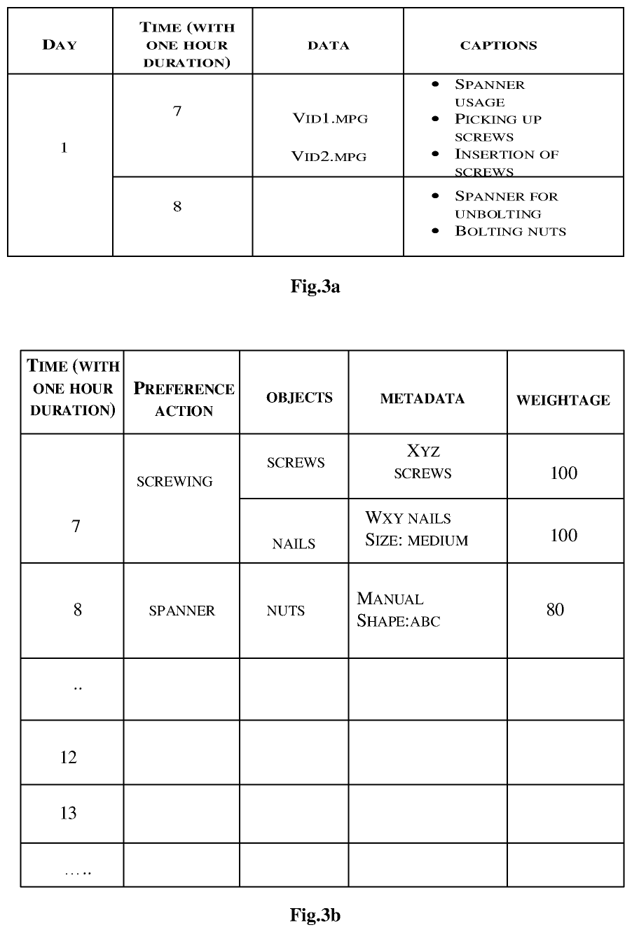

The interaction data 201 is associated with the plurality of automated task performing devices 103. Particularly, the interaction data 201 may include environment information which is collected over a period of time (say for example, fifteen days) during the interaction of each of the plurality of automated task performing devices 103 from the plurality sensing devices in the environment. The interaction data 201 includes the interactions of the automated task performing device with the one or more objects in the one or more environment, contextual information and one or more objects in the one or more environment. Further, the interaction data 201 may include critical information such as, timestamp associated with each interaction and location information obtained from Global Positioning System (GPS) coordinates tagged to the data. The interaction information includes the plurality of labeled activity data with associated timestamp. FIG. 3a shows an exemplary table of pre-determined interaction data in accordance with some embodiments of the present disclosure. As shown in the FIG. 3a, the table includes interaction data for a number of days with associated timestamp, datatype, and the associated labeled activity data.

The contextual data 203 includes a plurality of activities and corresponding one or more actions performed by a plurality of automated task performing devices in one or more environment. The contextual data 203 is determined based on the interaction information. Further, the contextual data 203 includes preference actions with associated timestamp, the state of one or more objects, weights assigned for each action and metadata information such as, type of action, frequency rate of object interactions and nature of object actions. FIG. 3b shows an exemplary table of prestored contextual data associated with an activity in accordance with some embodiments of the present disclosure. As shown in the FIG. 3b, the table includes timestamp associated with preference actions, state of object, metadata information and weights assigned for each action.

The machine learning model 205 may include one or more machine learning models for one or more actions. For instance, the one or more machine learning models may include CNN and LSTM models for providing dynamic learning for the automated task performing device and for generating plurality of labeled activity data. A person skilled in the art would understand that CNN and LSTM is exemplary combination and the machine learning models may also include any other machine learning combinations.

The other data 207 may store data, including temporary data and temporary files, generated by modules 211 for performing the various functions of the dynamic learning system 101.

In an embodiment, the data 200 in the memory 111 are processed by the one or more modules 211 present within the memory 111 of the dynamic learning system 101. In an embodiment, the one or more modules 211 may be implemented as dedicated units. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. In some implementations, the one or more modules 211 may be communicatively coupled to the processor 113 for performing one or more functions of the dynamic learning system 101. The said modules 211 when configured with the functionality defined in the present disclosure will result in a novel hardware.

In one implementation, the one or more modules 211 may include, but are not limited to a receiving module 213, an identification module 215, a dynamic learning module 217, a contextual information generation module 219 and action providing module 221. The one or more modules 211 may also include other modules 223 to perform various miscellaneous functionalities of the dynamic learning system 101. In an embodiment, the other modules 223 may include interaction captaining module, an alert generation module and an update module. The interaction captaining module is configured to receive the interaction data from the receiving module 213. The interaction captaining module converts data ingested in various formats into text format. For instance, in case of images, the objects and relations are captured through captioning. In case of videos, actions are also captured in text form. Further, for interpretation of logs, metadata in the text form may be used. In an embodiment, the interaction captaining module may caption the plurality of activity labeled data using a combination of Convolutional Neural Network (CNN) and Long Short-Term Memory (LSTM) models. Simultaneously, the interaction captaining module may extract the objects in the environment using existing extraction techniques such as, feature-based extraction. In an embodiment, interaction of each automated task performing device may be distinguished from interaction of other plurality of automated task performing devices 103. The alert generation module may receive notification from one or more modules and may generate alerts to the plurality of automated task performing devices 103. Particularly, the alert generation module may generate the alert based on predefined threshold values associated with each activity. The update module may continuously update the prestored contextual information based on learning from the one or more actions performed by the plurality of automated task performing devices 103.

The receiving module 213 may receive the interaction data from the plurality of sensing devices in the environment. In an embodiment, the receiving module 213 may receive the interaction data in heterogeneous format from the plurality of sensing devices through which the plurality of automated task performing devices 103 interacts with the environment. In an embodiment, the data can be, but not limited to, logs, images, voice, e-mail, text, videos, and the like. As it may be easy to handle data in form of text, the interaction data and corresponding description is converted into text. In case of videos and images, the converted text may include the labeled activity data, objects in the environment, interactions among the objects, responses from the objects or characters in the video and the like.

The identification module 215 may identify the one or more changes in the environment in which the automated task performing device is scheduled to perform one or more activities. In an embodiment, the identification module 215 may identify the one or more changes even when the automated task performing device is in inactive state. The identification module 215 may identify the one or more changes in the environment using the pre-determined interaction information associated with the automated task performing device using the one or more machine learning models.

Particularly, the identification module 215 may check scheduled activities at corresponding timeslots. In case of identifying any changes in the environment, the identification module 215 may provide notification to the alert generation module. In an embodiment, the one or more changes in the environment may be non-availability of interacting objects. In such case, the notification about the change is provided to the alert generation module. For example, in an industrial environment, if a user misplaces an object, for instance, a screw-driver/spanner, a robot, say Robot 1, may be alerted immediately regarding such a change, so that Robot 1 may find a replacement instead of getting surprised at the scheduled time of the activity. In another scenario, the one or more changes may be with respect to trigger of a similar activity at different schedule. For example, in an industrial environment a robot may visit an assembly floor at 12:00 noon instead of 13:00 PM. In such case, the identification module 215 identifies the change based on action performed earlier using the interaction information. Likewise, in another example, a change may be detected based on change in location of the automated task performing device. For example, like previous context, “Robot 1” travels to different floor for assembly work.

The dynamic learning module 217 may initiate a dynamic learning associated with the one or more changes for the automated task performing device. In an embodiment, the dynamic learning module 217 may receive information about the scheduled activity from the database 107. Based on the one or more changes identified in the environment, the dynamic learning module 217 performs the dynamic learning for the automated task performing device based on the prestored contextual information using the one or more machine learning models. Particularly, the dynamic learning module 217 using the one or more machine learning models corelates the one or more changes associated with the scheduled activity with similar activity performed by other automated task performing device of the plurality of automated task performing devices 103.

Thus, based on any one of the previously performed activity with similar context, the dynamic learning module 217 initiate the learning for the automated task performing device dynamically. In the environment with the one or more changes, the object of action or situation may be different, however actions to be performed can be relevant which are learnt over a period and stored continuously in contextual table. For example, considering industrial scenario, dimensions of the screws may be different, which the automated task performing device such as, the robot may not be exposed. In such condition, the dynamic learning module 217 may initiate the learning dynamically for changed dimensions of the screws. Thus, the robot may select correct screwdriver. The dynamic learning module 217 initiates the learning from the prestored contextual table, as the type of the object (i.e., screw) remains the same. In an embodiment, the correct screwdriver may be selected based on gazing of the size and nature of the objects.

The contextual information generation module 219 may generate a context table based on the interaction information, The context table may include the preference actions with associated timestamp, the state of one or more objects, the weights associated with each action and the metadata comprising type of action, frequency the rate of object interactions and the nature of object actions. Initially, the context table is generated by weighted averaging of interaction profile. In an embodiment, the weights may be set equal to the frequency or repetition of actions or interactions. The repetition may occur exactly at same time in a day or in a duration of the time. In an embodiment, the weights assigned may be proportional to the number of times the action or interaction is performed. For instance, a weight of “100” may be assigned if the same action repeats at the same time duration every day. However, if the same action repeats with different time slot or vice versa, such activity are captured and shown as separate items in the table. In addition, if an activity is performed only once or less frequently, such activities may be entered in a preferred table, depending on the nature of the actions. For example, while fixing screws is a daily routine action, un-screwing may not be a daily scheduled activity. FIG. 3c shows an exemplary preferred table in accordance with some embodiments of the present disclosure. As shown, the preferred table includes preferred activity with associated timestamp, metadata, and minimum time gap for performing the preferred activity. In an embodiment, if the automated task performing device makes use of an item/object very frequently, the activity associated with such item/object may be transferred from the preferred table to the contextual table. Further, the metadata spans brand (typically obtained from character recognition from the labels on the items), amount, size, color, shape, usage duration and the like.

In an embodiment, the state of the objects/events with which the plurality of automated task performing devices 103 interact are arranged based on preferred way associated with each automated task performing devices 103. In case of any disturbance in the environment, and if changed environment or situation is adaptable to the plurality of automated task performing devices 103, a new state of the environment/object may be retained as a possible like state in the context table.

In an embodiment, the plurality of automated task performing devices 103 may neglect to respond to any interaction stored in the contextual table. In such case, entries of relevant activities are deleted subsequently based on predefined thresholds. For example, if an automated task performing device neglects similar interaction or subsequent alerts about the same (assuming that overlooked) six times, the corresponding entry may be set as dormant. On the other hand, for instance, if the automated task performing device responds differently for the activity stored for the same kind of interaction consistently for more than the threshold value, for instance 6 times, the corresponding entry in the contextual table is updated. Similarly, consider if any of the plurality of automated task performing devices 103 encounter a new interaction, which is not available in the contextual table. In such case, if response provided for such interaction is consistent for a threshold time, say for instance, 15 times, in such case, the corresponding activity and response details are recorded to the contextual table.

The action providing module 221 may provide the one or more actions to the automated task performing device, exposed to the one or more changes, based on the dynamic learning. The one or more actions are provided to perform the one or more activities in view of the one more changes. In an embodiment, the one or more actions may include instructions for carrying out the one or more activities in view of the one more changes. For instance, in the industrial environment, the instructions to robot may be, “please use screwdriver for screwing and not spanner”. Thus, based on the dynamic learning, the automated task performing device learns the one or more activities dynamically and adjust to the situation accordingly. For instance, if the robot finds a nut or bolt, instead of the screw, the robot may try to see the situation where these objects may be used and apply fitment to that situation automatically.

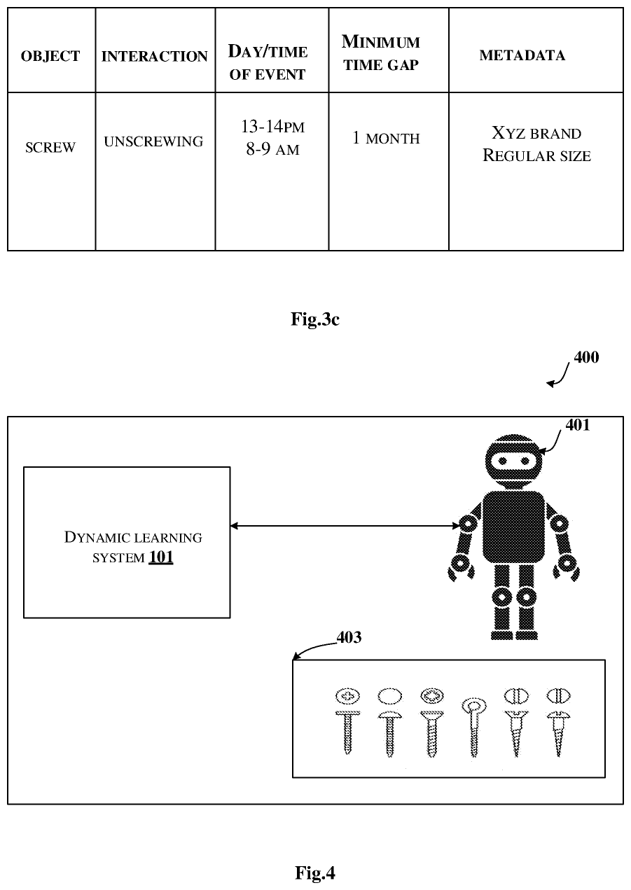

FIG. 4 shows an exemplary embodiment of an automated task performing device for dynamic cross-domain learning in accordance with some embodiments of present disclosure. FIG. 4 shows an automated task performing device, i.e. a robot 401. In current context, the robot 401 may be trained to handle different types of screwdrivers based on screws. Consider, that the robot 401 is shifted to an industrial assembly 400. The industrial assembly 400 includes screw objects 403. Suppose there is change in size and shape of screw and screwdriver different from the one the robot 401 may have learned previously. In such case, the dynamic learning system 101 may initiate the dynamic learning for the robot 401 using the contextual information associated with the industrial assembly 400. Based on the learning, the robot 401 may handle the screw objects 403 seamlessly and perform the activity.

### Exemplary Scenarios:

Assume a first scenario of a “digital twin”, in which a washing machine and its functionalities are to be verified without actually having access to real/physical device. As in digital twin, information is gathered about physical twin and using this contextual cues, usage patterns are built. Further, complete ecosystem and its surroundings are studied and based on self-training mechanism, the functionalities are verified. If in case certain operations (say, for instance, Require a dry wash, with 1000 rpm speed of rim, with 3-4 kg of clothes inside the washing machine) of “pressing button” is in some order and may not be reversed or performed in non-sequential pattern, then in such case, all the operations may have to be performed from beginning to repeat same steps. In such scenario, the present disclosure, with the “Digital twin Bot” may learn the context and dynamically adjusts and carries out the operation of pressing the buttons in required order. This helps in not only optimizing the number of steps, but also in optimizing overall operation of the specified task.

In another scenario, consider a situation where short testing times are required for a dashboard of connected vehicle. Particularly, objective is to carry out independent tests on most items like various features of the dashboard, such as, checking tyre pressure, fuel efficiency, fog lights on/off and the like. This requires accurate measurements, and sometimes the operations to be performed requires sequence of steps. In case, if any step is missed or domain is changed, the complete process may have to be carried out once again, starting from beginning. In such situation, with the present disclosure, dynamic determination and analysis of environment and situation is carried out which aids in to carry forward to next step of execution seamlessly. In case any step or operation is missing or wrongfully carried out or if the domain is changed, the same is learned and predicted and applied with correct measures.

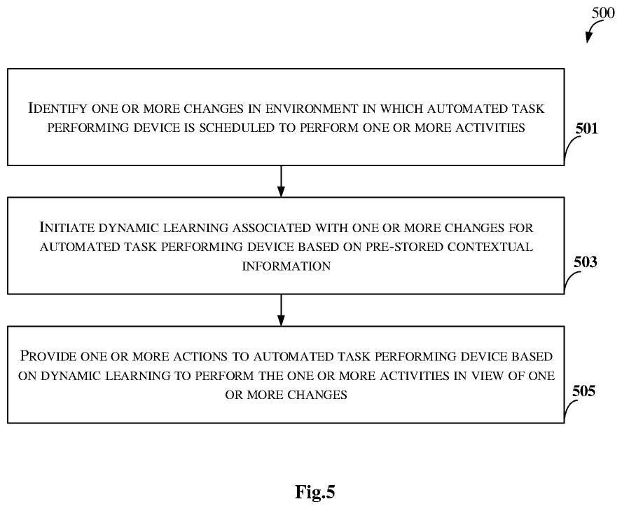

FIG. 5 illustrates a flowchart showing a method for providing dynamic cross-domain in accordance with some embodiments of present disclosure.

As illustrated in FIG. 5, the method 500 includes one or more blocks for providing dynamic cross-domain. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 501, the one or more changes in the environment is identified by the identification module 215, in which the automated task performing device is scheduled to perform the one or more activities. The one or more changes in the environment are identified based on the pre-determined interaction information associated with the automated task performing device.

At block 503, the dynamic learning is initiated by the dynamic learning module 217 for the one or more changes identified for the automated task performing device based on the pre-stored contextual information.

At block 505, the one or more actions are provided by the action providing module 221 to the automated task performing device based on the dynamic learning to perform the one or more activities in view of the one more changes.

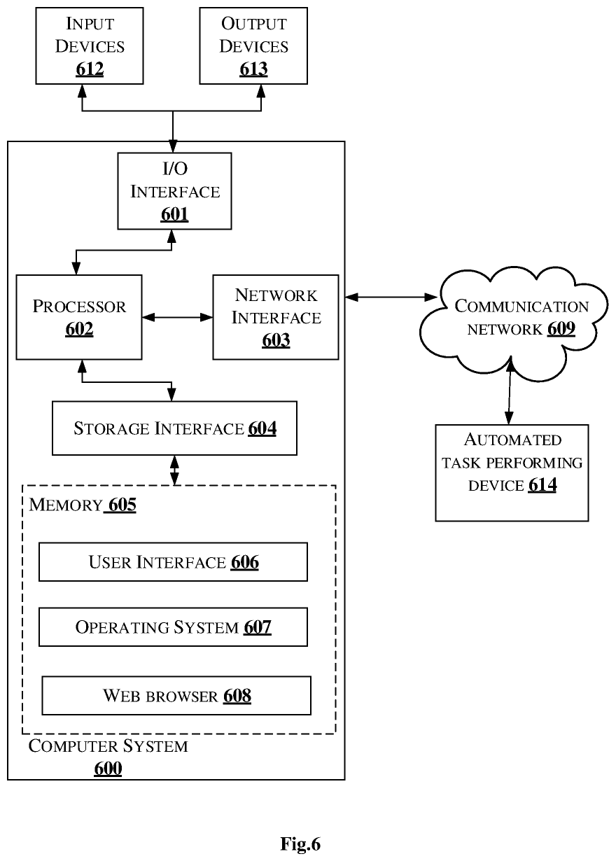

FIG. 6 illustrates a block diagram of an exemplary computer system 600 for implementing embodiments consistent with the present disclosure. In an embodiment, the computer system 600 may be used to implement the dynamic learning system 101. The computer system 600 may include a central processing unit (“CPU” or “processor”) 602. The processor 602 may include at least one data processor for providing dynamic cross-domain learning. The processor 602 may include specialized processing units such as, integrated system (bus) controllers, memory management control units, floating point units, graphics processing units, digital signal processing units, etc.

The processor 602 may be disposed in communication with one or more input/output (I/O) devices (not shown) via I/O interface 601. The I/O interface 601 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices such as input devices 612 and output devices 613. For example, the input devices 612 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 613 may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 600 consists of the dynamic learning system 101. The processor 602 may be disposed in communication with the communication network 609 via a network interface 603. The network interface 603 may communicate with the communication network 609. The network interface 603 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 609 may include, without limitation, a direct interconnection, local area network (LAN), wide area network (WAN), wireless network (e.g., using Wireless Application Protocol), the Internet, etc. Using the network interface 603 and the communication network 609, the computer system 600 may communicate with an automated task performing device 614. The network interface 603 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 609 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 602 may be disposed in communication with a memory 605 (e.g., RAM, ROM, etc. not shown in FIG. 6) via a storage interface 604. The storage interface 604 may connect to memory 605 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, user interface 606, an operating system 607 etc. In some embodiments, computer system 600 may store user/application data, such as, the data, variables, records, etc., as described in this disclosure. Such databases may be implemented as fault-tolerant, relational, scalable, secure databases such as Oracle or Sybase.

The operating system 607 may facilitate resource management and operation of the computer system 600. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 600 may implement a web browser 608 stored program component. The web browser 608 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 608 may utilize facilities such as AJAX™, DHTML™, ADOBE® FLASH™, JAVASCRIPT™, JAVA™, Application Programming Interfaces (APIs), etc. In some embodiments, the computer system 600 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 600 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure provides dynamic cross domain learning for the automated task performing devices. The automated task performing device may not explicitly express the activities, since the activities are derived based on the interaction with the environment.

An embodiment of the present disclosure aids in suggesting routine service at unknown geographies/location.

An embodiment of the present disclosure detects disturbances in routinely interacting environment in absence of the automated task performing device and generates alerts.

An embodiment of the present disclosure provides dynamic determination and analysis of any situation for better fitment.

An embodiment of the present disclosure provides on the fly decision-making ability to automated task performing devices by referring prestored contextual data to adjust to the situation seamlessly.

An embodiment of the present disclosure provided end-to end automation and thus avoids user interaction wherever possible.

The disclosed method and system overcome technical problem of performing dynamic cross-domain learning by performing a dynamic learning for an automated task performing device for changes identified in an environment in which the automated task performing device is scheduled to perform activities. Thus, based on the learning, one or more actions is provided to the automated task performing device to perform the one or more activities in view of the one more changes. Therefore, the present disclosure facilitates dynamic determination and analysis of environment and situation for the automated task performing device for performing the activities. Thus, leading to dynamic decision-making to provide adjustment to the automated task performing device in any situation.

Currently there are no mechanisms for performing cross-domain based learning for seamless transfer of dynamic information related to contextual activities. Conventional systems are highly application specific or capture static and preset parameters. Typically, the conventional mechanisms revolve around “user preference” as main criteria for selecting next course of actions. However, this approach lacks in identifying and suggesting actions with domain specific changes and does not provide dynamic interaction-based learning. Many conventional mechanisms perform actions based on stored preferences without updating them depending on new domain techniques. The conventional mechanisms do not include dynamic models, which addresses ever changing scenarios, other than the user preferences such as, surrounding environment, and various other factors, which may affect overall system.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessors and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 5 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral numerals

| Reference | |
|---|---|
| Number | Description |
| 101 | Dynamic learning system |
| 103 | Plurality of automated task performing devices |
| 105 | Communication network |
| 107 | Database |
| 109 | I/O interface |
| 111 | Memory |
| 113 | Processor |
| 200 | Data |
| 201 | Interaction data |
| 203 | Contextual data |
| 205 | Machine learning models |
| 207 | Other data |
| 211 | Modules |
| 213 | Receiving module |
| 215 | Identification module |
| 217 | Dynamic learning module |
| 219 | Contextual information determination module |
| 221 | Action providing module |
| 223 | Other modules |
| 401 | Robot |
| 403 | Screw objects |
| 600 | Computer system |
| 601 | I/O interface |
| 602 | Processor |
| 603 | Network interface |
| 604 | Storage interface |
| 605 | Memory |
| 606 | User interface |
| 607 | Operating system |
| 608 | Web browser |
| 609 | Communication network |
| 611 | Input devices |
| 612 | Output devices |
| 614 | Automated task performing device |

What is claimed is:

1. A method of providing dynamic cross-domain learning, the method comprising:
identifying, by a dynamic learning system, one or more changes in an environment in which an automated task performing device is scheduled to perform one or more activities;
initiating, by the dynamic learning system, a dynamic learning associated with the one or more changes for the automated task performing device based on pre-stored contextual information; and
providing, by the dynamic learning system, one or more actions to the automated task performing device based on the dynamic learning to perform the one or more activities in view of the one more changes.

2. The method as claimed in claim 1, wherein the one or more changes in the environment are identified based on pre-determined interaction information associated with the automated task performing device, the pre-determined interaction information comprises a plurality of labeled activity data with associated timestamp.

3. The method as claimed in claim 2, wherein the interaction information is determined by capturing, via a plurality of sensing devices, interactions of the automated task performing device with one or more objects in one or more environment and one or more objects in the one or more environment.

4. The method as claimed in claim 1, wherein the pre-stored contextual information comprises a plurality of activities and corresponding one or more actions performed by a plurality of automated task performing devices in one or more environment.

5. The method as claimed in claim 1 further comprising providing an alert to the automated task performing device on identifying the one or more changes in the environment.

6. The method as claimed in claim 1, wherein the dynamic learning is performed using one or more machine learning models.

7. The method as claimed in claim 1 further comprising:
monitoring the one or more actions performed by the automated task performing device; and
updating the pre-stored contextual information based on the monitoring of the one or more actions and corresponding predefined thresholds.

8. The method as claimed in claim 1, wherein the contextual information is determined based on the interaction information and comprises preference actions with associated timestamp, a state of one or more objects, weights associated with each action and metadata comprising type of action, frequency rate of object interactions and nature of object actions.

9. A dynamic learning system for providing dynamic cross-domain learning, comprising:
a processor; and
a memory communicatively coupled to the processor, wherein the memory stores processor instructions, which, on execution, causes the processor to:
identify one or more changes in an environment in which an automated task performing device is scheduled to perform one or more activities;
initiate a dynamic learning associated with the one or more changes for the automated task performing device based on pre-stored contextual information; and
provide one or more actions to the automated task performing device based on the dynamic learning to perform the one or more activities in view of the one more changes.

10. The dynamic learning system as claimed in claim 9, wherein the processor identifies the one or more changes in the environment based on pre-determined interaction information associated with the automated task performing device, the pre-determined interaction information comprises a plurality of labeled activity data with associated timestamp.

11. The dynamic learning system as claimed in claim 10, wherein the processor determines the interaction information by capturing, via a plurality of sensing devices, interactions of the automated task performing device with one or more objects in one or more environment and one or more objects in the one or more environment.

12. The dynamic learning system as claimed in claim 9, wherein the pre-stored contextual information comprises a plurality of activities and corresponding one or more actions performed by a plurality of automated task performing devices in one or more environment.

13. The dynamic learning system as claimed in claim 9, wherein the processor provides an alert to the automated task performing device on identifying the one or more changes in the environment.

14. The dynamic learning system as claimed in claim 9, wherein the processor performs the dynamic learning using one or more machine learning models.

15. The dynamic learning system as claimed in claim 9, wherein the processor:
monitors the one or more actions performed by the automated task performing device; and
updates the pre-stored contextual information based on the monitoring of the one or more actions and corresponding predefined thresholds.

16. The dynamic learning system as claimed in claim 9, wherein the processor determines the contextual information based on the interaction information and comprises preference actions with associated timestamp, a state of one or more objects, weights associated with each action and metadata comprising type of action, frequency rate of object interactions and nature of object actions.

17. A non-transitory computer readable medium including instruction stored thereon that when processed by at least one processor cause a dynamic learning system to perform operation comprising:
identifying one or more changes in an environment in which an automated task performing device is scheduled to perform one or more activities;
initiating a dynamic learning associated with the one or more changes for the automated task performing device based on pre-stored contextual information; and
providing one or more actions to the automated task performing device based on the dynamic learning to perform the one or more activities in view of the one more changes.
